(19) United States
(12) Patent Application Publication
(10) Pub. No.: US 2006/0076875 A1
(43) Pub. Date: Apr. 13, 2006

(54) Plasma display panel

(76) Inventor: Woo Tae Kim, Yongin-si (KR)

Correspondence Address: MCKENNA LONG & ALDRIDGE LLP, 1900 K STREET, NW, WASHINGTON, DC, 20006, US

(21) Appl. No.: 11/244,169

(22) Filed: Oct. 6, 2005

(30) Foreign Application Priority Data
Oct. 8, 2004 (KR) 10-2004-0080640

(51) Int. Cl. H01J 1/62

(52) U.S. Cl. 313/483

(57) ABSTRACT

Disclosed is a plasma display panel, more particularly, a plasma display panel comprising scanning bus electrodes and sustaining bus electrodes formed on top of RGB cells. The plasma display panel comprises a first discharge cell provided with a first phosphor among a plurality of phosphors, a second discharge cell provided with a second phosphor among the plurality of phosphors, a first sustaining electrode pair formed on the first discharge cell and having a first area, and a second sustaining electrode pair formed on the second discharge cell and having a second area smaller than the first area. The color temperature of an image displayed by a plasma display panel can be set to appropriate level by enlarging the area of electrodes in the regions of a discharge cell provided with a specific phosphor.

This Nonprovisional application claims priority under 35 U.S.C. § 119(a) on Patent Application No. 10-2004-0080640 filed in Korea on Oct. 8, 2004, the entire contents of which are hereby incorporated by reference.

### BACKGROUND OF THE INVENTION

1. Field of the Invention

The present invention relates to a plasma display panel, and more particularly, to a plasma display panel comprising scanning bus electrodes and sustaining bus electrodes formed on R, G and B cells.

2. Background of the Related Art

In a conventional plasma display panel, a barrier rib formed between front and rear substrates made of soda-lime glass constitutes one unit cells, Each cell is filled with an inert gas such as helium-xenon(He—Xe), helium-neon(He—Ne), etc., If the inert gas is discharged with a high frequency voltage, vacuum ultraviolet rays are generated. Phosphor formed between the barrier ribs emits light corresponding to images.

FIG. 1 is a perspective view schematically showing the structure of a conventional plasma display panel. As shown in FIG. 1, the plasma display panel comprises a front glass substrate 10 and a rear glass substrate 20. The front glass substrate 10 and the rear glass substrate 20 are coupled in parallel to each other with a predetermined distance therebetween.

A sustaining electrode pair 11 and 12 for sustaining the light emission of a discharge cell is formed on the front glass substrate 10. The sustaining electrode pair 11 and 12 consists of a scan electrode 11 and sustain electrode 12. The scan electrode 11 is supplied with a scan pulse for scanning and a sustain pulse for sustaining discharging. The sustain electrode 12 is applied with a sustain pulse alternated with a sustain pulse applied to the scan electrode 11. The scan electrode 11 and the sustain electrode 12 are composed of transparent electrodes 11a and 12a made of transparent ITO material and bus electrodes 11b and 12b made of metal, respectively. The sustaining electrode pair 11 and 12 are covered with a dielectric layer 13a. A protective layer 14 made of MgO is formed on the upper surface of the dielectric layer 13a so as to facilitate discharging more easily.

A plurality of address electrodes 22 are arranged on the rear glass substrate 20 alternatively with the sustaining electrode pair 11 and 12. A dielectric layer 13b is formed on the address electrodes 22. Barrier ribs 21 for forming discharge cells are formed on the dielectric layer 13b. A phosphor 23 for emitting visible light is coated between the barrier ribs 21.

FIG. 2 shows an electrode structure of the conventional plasma display panel. As shown in FIG. 2, the bus electrodes 11a and 11b are formed at upper and lower parts of a discharge cell 30 coated with R(red) phosphor, a discharge cell 40 coated with G(green) phosphor and a discharge cell 50 coated with B(blue) phosphor. The transparent electrodes 12a and 12b are formed in such a manner to be projected from the bus electrodes 11a and 11b toward the center of the discharge cell 30 coated with R(red) phosphor, of the discharge cell 40 coated with G(green) phosphor, and of the discharge cell 50 coated with B(blue) phosphor.

The bus electrodes 11a and 11b and transparent electrodes 12a and 12b formed on the regions of each discharge cell have the same area. As a result, when discharging occurs in each of the discharge cells, the amount of discharge is the same. Since the amount of discharge is the same in each discharge cell, the discharge efficiency in each discharge cell is significantly depending on the phosphor type. The emission efficiency of B phosphor is less than the emission efficiency of R phosphor or G phosphor. That is, the amount of light emitted from the B phosphor according to a specific amount of discharge is less than the amount of light emitted from the R phosphor or G phosphor. Therefore, if the area of the electrodes formed on each discharge cell is the same, the color temperature of an image displayed by the conventional plasma display panel is not being set to an appropriate level.

### SUMMARY OF THE INVENTION

Accordingly, an object of the present invention is to solve at least the problems and disadvantages of the background art.

The present invention provides a plasma display panel comprising electrodes with an enhanced structure for improvement of color temperature.

The plasma display panel of the present invention comprises: a first discharge cell provided with a first phosphor among a plurality of phosphors; a second discharge cell provided with a second phosphor among the plurality of phosphors; a first sustaining electrode pair formed on the first discharge cell and having a first area; and a second sustaining electrode pair formed on the second discharge cell and having a second area smaller than the first area.

The plasma display panel of the present invention comprises: a first discharge cell partitioned by barrier ribs and provided with a first phosphor among a plurality of phosphors; a second discharge cell partitioned by barrier ribs and provided with a second phosphor among the plurality of phosphors; a first transparent electrode portion projected on the first discharge cell toward the center of the first discharge cell and having a first partial area; and a second transparent electrode portion projected on the second discharge cell toward the center of the second discharge cell and having a second partial area smaller than the first partial area.

In the present invention, the color temperature of an image displayed by a plasma display panel is set to the appropriate level by enlarging the area of electrodes in the regions of a discharge cell provided with a specific phosphor.

### BRIEF DESCRIPTION OF THE DRAWINGS

The invention will be described in detail with reference to the following drawings in which like numerals refer to like elements:

FIG. 1 is a perspective view schematically showing a structure of a conventional plasma display panel;

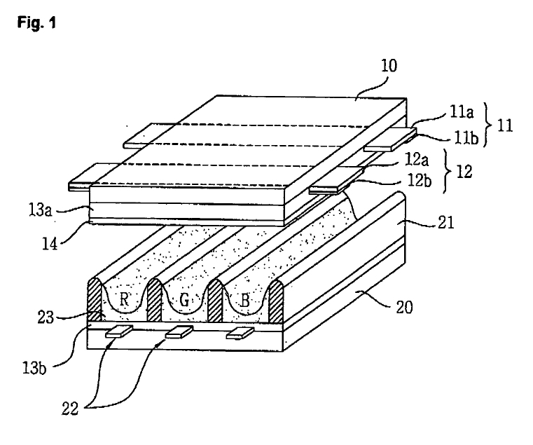

FIG. 2 shows an electrode structure of the conventional plasma display panel;

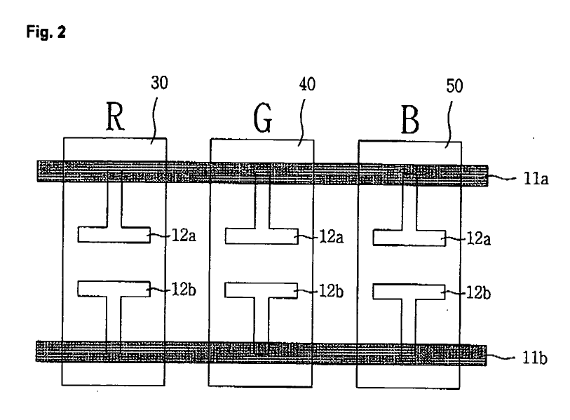

FIG. 3 is a plane view of a plasma display panel according to a first embodiment of the present invention; and

FIG. 4 is a plane view of a plasma display panel according to a second embodiment of the present invention.

### DETAILED DESCRIPTION OF THE PREFERRED EMBODIMENTS

Preferred embodiments of the present invention will be described in a more detailed manner with reference to the drawings.

The plasma display panel of the present invention comprises: a first discharge cell provided with a first phosphor among a plurality of phosphors; a second discharge cell provided with a second phosphor among the plurality of phosphors; a first sustaining electrode pair formed on the first discharge cell and having a first area; and a second sustaining electrode pair formed on the second discharge cell and having a second area smaller than the first area.

The first phosphor is a blue phosphor.

The first sustaining electrode pair comprises a first scanning bus electrode, the second sustaining electrode pair comprises a second scanning bus electrode, and the first scanning bus electrode is wider than the second scanning bus electrode.

The first sustaining electrode pair comprises a first scanning bus electrode, the second sustaining electrode pair comprises a second scanning bus electrode, and the first scanning bus electrode is wider than the second scanning bus electrode.

The plasma display panel of the present invention comprises: a first discharge cell partitioned by barrier ribs and provided with a first phosphor among a plurality of phosphors; a second discharge cell partitioned by barrier ribs and provided with a second phosphor among the plurality of phosphors; a first transparent electrode portion projected on the first discharge cell toward the center of the first discharge cell and having a first partial area; and a second transparent electrode portion projected on the second discharge cell toward the center of the second discharge cell and having a second partial area smaller than the first partial area.

The first phosphor is a blue phosphor.

The first transparent electrode portion comprises a first scanning vertical connecting portion formed toward the center of the first discharge cell, the second transparent electrode portion comprises a second scanning vertical connecting portion formed toward the center of the second discharge cell, and the first scan vertical connecting portion is wider than the second scanning vertical connecting portion.

The first scanning vertical connecting portion is wider than the second scanning vertical connecting portion, and the width of the first scanning vertical connecting portion increases in the direction of the barrier ribs partitioning the first discharge cell.

The first transparent electrode portion further comprises a first scanning horizontal connecting portion connecting to the first scanning vertical connecting portion, the second transparent electrode portion further comprises a second scanning horizontal connecting portion connecting to the second scanning vertical connecting portion, and the first scanning horizontal connecting portion is wider than the second scanning horizontal connecting portion.

The first scanning horizontal connecting portion is wider than the second scanning horizontal connecting portion, and the width of the first scanning horizontal connecting portion increases in the direction of the barrier ribs partitioning the first discharge cell.

The first transparent electrode portion comprises a first sustaining vertical connecting portion formed toward the center of the first discharge cell, the second transparent electrode portion comprises a second sustaining vertical connecting portion formed toward the center of the second discharge cell, and the first sustaining vertical connecting portion is wider than the second sustaining vertical connecting portion.

The first sustaining vertical connecting portion is wider than the second sustaining vertical connecting portion, and the width of the first sustaining vertical connecting portion increases in the direction of the barrier ribs partitioning the first discharge cell.

The first transparent electrode portion further comprises a first sustaining horizontal connecting portion connecting to the first sustaining vertical connecting portion, the second transparent electrode portion further comprises a second sustaining horizontal connecting portion connecting to the second sustaining vertical connecting portion, and the first sustaining horizontal connecting portion is wider than the second sustaining horizontal connecting portion.

The first sustaining horizontal connecting portion is wider than the second sustaining horizontal connecting portion, and the width of the first sustaining horizontal connecting portion increases in the direction of the barrier ribs partitioning the first discharge cell.

Hereinafter, specific embodiments of the present invention will be described with reference to the accompanying drawings.

### Embodiment 1

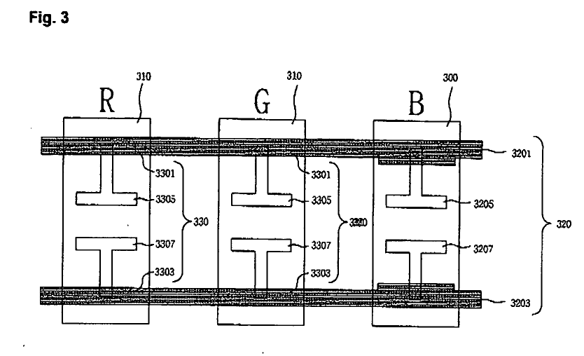

FIG. 3 is a plane view of a plasma display panel according to a first embodiment of the present invention. As shown in FIG. 3, the plasma display panel comprises a first discharge cell 300, a second discharge cell 310, a first sustaining electrode pair 320 and a second sustaining electrode pair 330.

The first discharge cell 300 is partitioned by barrier ribs and provided with a first phosphor among a plurality of phosphors. It is preferable that the plurality of phosphor comprises a R(red) phosphor, a G(green) phosphor and a B(blue) phosphor. Preferably, the first phosphor is a B phosphor.

The second discharge cell 310 is partitioned by barrier ribs and provided with a second phosphor among a plurality of phosphors. Preferably, the first phosphor is a R(red) phosphor or a G(green) phosphor.

The first sustaining electrode pair 320 is formed on a front glass substrate (not shown) on the first discharge cell 300 and has a first area. Such first sustaining electrode pair 320 comprise a first scanning bust electrode 3201, a first sustaining bus electrode 3203, a first scanning transparent electrode 3205 and a first sustaining transparent electrode 3207. The position of the first scanning bus electrode 3201 and the first scanning transparent electrode 3205, and the position of the first sustaining bus electrode 3203 and the first sustaining transparent electrode 3207 can alternate with each other. That is, the first scanning bus electrode 3201 and the first scanning transparent electrode 3205 can be positioned at a lower part of the first discharge cell 300, and the first sustaining bus electrode 3203 and the first sustaining transparent electrode 3207 can be positioned at an upper part of the first discharge cell 300.

The second sustaining electrode pair 330 is formed on a front glass substrate (not shown) on the second discharge cell 310 and has a second area smaller than the first area. Such second sustaining electrode pair 330 comprises a second scanning bust electrode 3301, a second sustaining bus electrode 3303, a second scanning transparent electrode 3305 and a second sustaining transparent electrode 3307. The position of the second scanning bus electrode 3301 and the second scanning transparent electrode 3305, and the position of the second sustaining bus electrode 3303 and of the second sustaining transparent electrode 3307 can alternate with each other. That is, the second scanning bus electrode 3301 and the second scanning transparent electrode 3305 can be positioned at a lower part of the second discharge cell 310, and the second sustaining bus electrode 3303 and the second sustaining transparent electrode 3307 can be positioned at an upper part of the second discharge cell 310.

As shown in FIG. 3, the first scanning bus electrode 3201 and first sustaining bus electrode 3203 of the first sustaining electrode pair 320 is wider than the second scanning bus electrode 3301 and second sustaining bus electrode 3303 of the second sustaining electrode pair 330. As a result, as the first scanning bus electrode 3201 and the first sustaining bus electrode 3203 are formed on the first discharge cell 300 where the B phosphor is formed, and the second scanning bus electrode 3301 and the second sustaining bus electrode 3303 are formed on the second discharge cell 310 where the R phosphor or G phosphor is formed, the amount of discharge of the first discharge cell 300 becomes greater than the amount of discharge of the second discharge cell 310. Therefore, because the first discharge cell in which the B phosphor having a smaller light emission efficiency is formed, emits a greater amount of light than an amount of light emitted by the second discharge cell, the color temperature of an image displayed by the plasma display panel can be set to the appropriate level.

### Embodiment 2

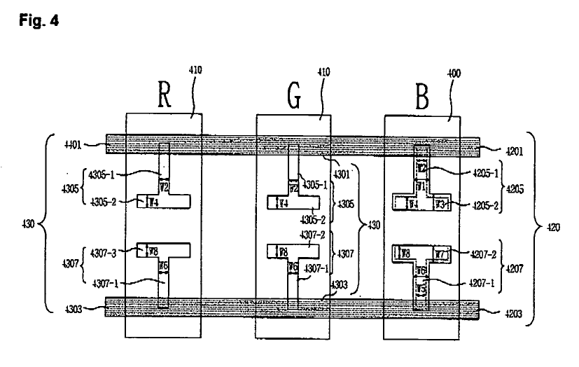

FIG. 4 is a plane view of a plasma display panel according to a first embodiment of the present invention. As shown in FIG. 4, the plasma display panel comprises a first discharge cell 400, a second discharge cell 410, a first sustaining electrode pair 420 and a second sustaining electrode pair 430.

The first discharge cell 400 is partitioned by barrier ribs and provided with a first phosphor among a plurality of phosphors. It is preferable that the plurality of phosphor comprises a R(red) phosphor, a G(green) phosphor and a B(blue) phosphor. Preferably, the first phosphor is a B phosphor.

The second discharge cell 410 is partitioned by barrier ribs and provided with a second phosphor among a plurality of phosphors. Preferably, the first phosphor is a R(red) phosphor or G(green) phosphor.

The first sustaining electrode pair 420 is formed on a front glass substrate (not shown) on the first discharge cell 400 and has a first area. Such first sustaining electrode pair 420 comprise a first scanning bust electrode 4201, a first sustaining bus electrode 4203, a first scanning transparent electrode 4205 and a first sustaining transparent electrode 4207. The position of the first scanning bus electrode 4201 and the first scanning transparent electrode 4205, and the position of the first sustaining bus electrode 4203 and of the first sustaining transparent electrode 4207 can alternate with each other. That is, the first scanning bus electrode 4201 and the first scanning transparent electrode 4205 can be positioned at a lower part of the first discharge cell 400, and the first sustaining bus electrode 4203 and the first sustaining transparent electrode 4207 can be positioned at an upper part of the first discharge cell 400. The first scanning transparent electrode 4205 and the first sustaining transparent electrode 4207 are projected from the first scanning bus electrode 4201 and the first sustaining bus electrode 4203, respectively, toward the center of the first discharge cell 400. The first scanning transparent electrode 4205 and the first sustaining transparent electrode 4207 have a first partial area. That is, the first partial area is the sum of the areas of the first scanning transparent electrode 4205 and first sustaining transparent electrode 4207. The first scanning transparent electrode 4205 comprises a first scanning vertical connecting portion 4205-1 vertically connecting to the first scanning bus electrode 4201 and a first scanning horizontal connecting portion 4205-2 vertically connecting to the first scanning vertical connecting portion 4205-1. The first sustaining transparent electrode 4207 comprises a first sustaining vertical connecting portion 4207-1 vertically connecting to the first sustaining bus electrode 4203 and a first sustaining horizontal connecting portion 4207-2 vertically connecting to the first sustaining vertical connecting portion 4207-1.

The second sustaining electrode pair 430 is formed on a front glass substrate (not shown) on the second discharge cell 410 and has a second area smaller than the first area. Such second sustaining electrode pair 430 comprises a second scanning bust electrode 4301, a second sustaining bus electrode 4303, a second scanning transparent electrode 4305 and a second sustaining transparent electrode 4307. The position of the second scanning bus electrode 4301 and the second scanning transparent electrode 4305, and the position of the second sustaining bus electrode 4303 and of the second sustaining transparent electrode 4307 can be alternate with each other. That is, the second scanning bus electrode 4301 and the second scanning transparent electrode 4305 can be positioned at a lower part of the second discharge cell 410, and the second sustaining bus electrode 3303 and the second sustaining transparent electrode 4307 can be positioned at an upper part of the second discharge cell 410. The second scanning transparent electrode 4305 and the second sustaining transparent electrode 4307 are projected from the second scanning bus electrode 4201 and the second sustaining bus electrode 4303, respectively, toward the center of the second discharge cell 410. The second scanning transparent electrode 4305 and the second sustaining transparent electrode 4307 have a second partial area. That is, the second partial area is the sum of the areas of the second scanning transparent electrode 4305 and second sustaining transparent electrode 4307. The second scanning transparent electrode 4305 comprises a second scanning vertical connecting portion 4305-1 vertically connecting to the second scanning bus electrode 4301 and a second scanning horizontal connecting portion 4305-2 vertically connecting to the second scanning vertical connecting portion 4205-1. The second sustaining transparent electrode 4307 comprises a second sustaining vertical connecting portion 4307-1 vertically connecting to the second sustaining bus electrode 4303 and a second sustaining horizontal connecting portion 4307-2 vertically connecting to the second sustaining vertical connecting portion 4307-1.

As shown in FIG. 4, the first partial area of the first scanning transparent electrode 4205 and the first sustaining transparent electrode 4207 is larger than the second area of the second scanning transparent electrode 4305 and second sustaining transparent electrode 4307. As a result, as the first scanning transparent electrode 4205 and the first sustaining transparent electrode 4207 are formed on the first discharge cell 400 where the B phosphor is formed, and the second scanning transparent electrode 4305 and the second sustaining transparent electrode 4307 are formed on the second discharge cell 410 where the R phosphor or G phosphor is formed, the amount of discharge of the first discharge cell 400 becomes greater than the amount of discharge of the second discharge cell 410. Therefore, because the B phosphor having a lower light emission efficiency emits a greater amount of light, the color temperature of an image displayed by the plasma display panel can be set to the appropriate level. The width w1 of the first scanning vertical connecting portion 4205-1 of the first scanning transparent electrode 4205 can be wider than the width w2 of the second scanning vertical connecting portion 4305-1 of the second scanning transparent electrode 4305. The width w3 of the first scanning horizontal connecting portion 4305-2 of the second scanning transparent electrode 4305 can be wider than the width w4 of the second scanning horizontal connecting portion 4305-2 of the second scanning transparent electrode 4305. Likewise, the width w6 of the first sustaining vertical connecting portion 4207-1 of the first sustaining transparent electrode 4207 can be wider than the width w5 of the second sustaining vertical connecting portion 4307-1 of the second sustaining transparent electrode 4307. The width w7 of the first sustaining horizontal connecting portion 4207-1 of the first sustaining transparent 4207 can be wider than the width w8 of the second sustaining horizontal connecting portion 4307-2 of the second sustaining transparent electrode 4307.

If the width of the first scanning horizontal connecting portion 4205-2 and first sustaining horizontal connecting portion 4207-2 increases toward the center of the first discharge cell 400, a discharge gap is reduced and thus a discharge firing voltage increases. As a result, it is preferable that the first scanning horizontal connecting portion 4205-2 and the first sustaining horizontal connecting portion 4207-2 have a width that increases toward the barrier ribs, respectively.

The invention being thus described, it will be obvious that the same may be varied in many ways. Such variations are not to be regarded as a departure from the spirit and scope of the invention, and all such modifications as would be obvious to one skilled in the art area intended to be comprised within the scope of the following claims.

What is claimed is:

1. A plasma display panel, comprising:
a first discharge cell comprising first phosphor among a plurality of phosphors is formed;
a second discharge cell comprising second phosphor among the plurality of phosphors is formed;
a first sustaining electrode pair formed on the first discharge cell and having a first area; and
a second sustaining electrode pair formed on the second discharge cell and having a second area smaller than the first area.

2. The plasma display panel as claimed in claim 1, wherein the first phosphor is a blue phosphor.

3. The plasma display panel as claimed in claim 1, wherein the first sustaining electrode pair comprises a first scanning bus electrode, the second sustaining electrode pair comprises a second scanning bus electrode, and the first scanning bus electrode is wider than the second scanning bus electrode.

4. The plasma display panel as claimed in claim 11, wherein the first sustaining electrode pair comprises a first sustaining bus electrode, the second sustaining electrode pair comprises a second sustaining bus electrode, and the first sustaining bus electrode is wider than the second scanning bus electrode.

5. A plasma display panel, comprising;
a first discharge cell partitioned by barrier ribs and comprising first phosphor among a plurality of phosphors is formed;
a second discharge cell partitioned by barrier ribs and provided with a second phosphor among the plurality of phosphors is formed;
a first transparent electrode portion projected on the first discharge cell toward the center of the first discharge cell and having a first partial area; and
a second transparent electrode portion projected on the second discharge cell toward the center of the second discharge cell and having a second partial area smaller than the first partial area.

6. The plasma display panel as claimed in claim 5, wherein the first phosphor is a blue phosphor.

7. The plasma display panel as claimed in claim 5, wherein the first transparent electrode portion comprises a first scanning vertical connecting portion formed toward the center of the first discharge cell, the second transparent electrode portion comprises a second scanning vertical connecting portion formed toward the center of the second discharge cell, and the first scan vertical connecting portion is wider than the second scanning vertical connecting portion.

8. The plasma display panel as claimed in claim 7, wherein the first scanning vertical connecting portion is wider than the second scanning vertical connecting portion, and the width of the first scanning vertical connecting portion increases in the direction of the barrier ribs partitioning the first discharge cell.

9. The plasma display panel as claimed in claim 7, wherein the first transparent electrode portion further comprises a first scanning horizontal connecting portion connecting to the first scanning vertical connecting portion, the second transparent electrode portion further comprises a second scanning horizontal connecting portion connecting to the second scanning vertical connecting portion, and the first scanning horizontal connecting portion is wider than the second scanning horizontal connecting portion.

10. The plasma display panel as claimed in claim 9, wherein the first scanning horizontal connecting portion is wider than the second scanning horizontal connecting portion, and the width of the first scanning horizontal connecting portion increases in the direction of the barrier ribs partitioning the first discharge cell.

11. The plasma display panel as claimed in claim 5, wherein the first transparent electrode portion comprises a first sustaining vertical connecting portion formed toward the center of the first discharge cell, the second transparent electrode portion comprises a second sustaining vertical connecting portion formed toward the center of the second discharge cell, and the first sustaining vertical connecting portion is wider than the second sustaining vertical connecting portion.

12. The plasma display panel as claimed in claim 11, wherein the first sustaining vertical connecting portion is wider than the second sustaining vertical connecting portion, and the width of the first sustaining vertical connecting portion increases in the direction of the barrier ribs partitioning the first discharge cell.

13. The plasma display panel as claimed in claim 11, wherein the first transparent electrode portion further comprises a first sustaining horizontal connecting portion connecting to the first sustaining vertical connecting portion, the second transparent electrode portion further comprises a second sustaining horizontal connecting portion connecting to the second sustaining vertical connecting portion, and the first sustaining horizontal connecting portion is wider than the second sustaining horizontal connecting portion.

14. The plasma display panel as claimed in claim 13, wherein the first sustaining horizontal connecting portion is wider than the second sustaining horizontal connecting portion, and the width of the first sustaining horizontal connecting portion increases in the direction of the barrier ribs partitioning the first discharge cell.
